(19) United States
(12) Patent Application Publication
(10) Pub. No.: US 2006/0188680 A1
(43) Pub. Date: Aug. 24, 2006

(54) Method for giving a concrete surface visual and tactile detectable warnings through adhesive means, resulting surface, and components

(76) Inventor: James Carl Everett, Surprise, AZ (US)

Correspondence Address: Jami Butler, 5665 W. Galveston #98, Chandler, AZ, 85226, US

(21) Appl. No.: 11/063,128

(22) Filed: Feb. 22, 2005

(51) Int. Cl. B32B 33/00

(52) U.S. Cl. 428/40.1

(57) ABSTRACT

A method for giving a concrete surface visual and tactile detectable warnings through adhesive means, the resulting surface, and components of the method are what is described. By adhering the truncated domes to the concrete, installation time is decreased and other costs are averted. This method can be used on a new surface and can also be used to retrofit existing surfaces.

### BACKGROUND OF THE INVENTION

The present invention relates to pedestrian walkways, ramps, platforms and curbs and all other surfaces that could be used by pedestrians.

For the visually impaired, there is a need for a warning system in public transit facilities to decrease the level of risk of inadvertent street entry associated with the presence of curb ramps. Detectable warnings complying with existing ADAAG requirements can provide an effective stop signal for the visually impaired to determine the end of a sidewalk and the beginning of a vehicular way.

American with Disabilities Act (ADA): “Accessibility Guidelines for Buildings and Facilities” instill the guidelines for the use of detectable warnings associated with the presence of curb ramps, walking surfaces, platforms and the like. The guidelines state that detectable warnings are to be in the form of a truncated dome with a base diameter of 0.9 to 1.4 inches, a top diameter of 50% to 65% of the base diameter, a height of 0.2 inch, a center-to-center spacing of 1.6 to 2.4 inches measured along one side of a square arrangement, and a base-to-base spacing of a minimum of 0.65 inches measured between the most adjacent domes on a square grid. However, these are just the suggestions of the administrative authority and practice has proved that they are lenient. The detectable warning surface must contrast visually with the adjoining surface, either light-on-dark or dark-on-light. The visual contrast must be a minimum of 70 percent in light reflectance between the detectable warning and an adjoining surface. The material used to provide visual contrast must be an integral part of the detectable warning surface. The location of the detectable warnings is to be such that the edge nearest the curb line or other potential hazard is 6 to 8 inches from the curb line or other potential hazard. Placement of the detectable warnings a maximum of 6 to 8 inches back from the curb line gives some latitude in placement of the detectable warning. Curb ramps are required to have detectable warnings extending the full width and depth of the curb ramp. Curbing embedded at the sidewalk/street junction is not required to be replaced. Platform edges bordering a drop off and that are not protected by guardrails or screens must have a detectable warning 24 inches wide that runs the full length of the platform drop off. If a walkway adjoins or crosses a vehicular way and the two are not separated by curbs or railing, the boundary between the areas is to have a continuous detectable warning that is 36 inches wide. Again it should be mentioned that the above guidelines are merely suggestions and the administrative authority has been lenient up to this point on the accepted dimensions.

Known within the art are ways to produce the above mentioned detectable warnings by using a stamp with indentions on a wet concrete surface. U.S. Pat. No. 5,271,690 issued to Fennessy, Sr. describes this method. The end result is a concrete surface with detectable warnings. However, use of this method is very expensive and labor intensive. It is also limited to the initial forming of the concrete surface and cannot be used to retrofit an existing surface.

Also know within the art is a pre-cast textured tile system and method for positioning on a necessary surface. U.S. Pat. No. 5,385,770 issued to Julnes describes this method. Described is a “mask” used to create a pattern of holes. A viscous substance is poured into the holes and the mask is then removed exposing raised detectable warnings on the surface. The apertures are supposed to resemble elongated ellipses. The resulting detectable warnings have a length of approximately 1.5”, a length of approximately 0.8”, and a height of approximately 0.14”. After applied to the appropriate surface, the end result of this invention is a surface with detectable warnings. In theory this is seemingly a good, inexpensive way to form detectable warning systems. However, in practice, particularly in areas that experience extremely warm temperatures, these pre-cast tiles have trouble adhering to the surface and either bubble up or peel off. In this event, an even greater danger is imposed on the handicap or visually impaired person who crosses the surface. Also, the liability on the owner of the surface on which these tiles are placed increases dramatically.

An attempt has been made to decrease the inherent problems with the pre-cast textured tile system for forming detectable warnings in U.S. patent application Ser. No. 0040042850 submitted by Provenzano, Peter J. III. This system describes laying the pre-cast tiles in fresh concrete. This may solve the above-mentioned problems but describes a very different method of doing so than our present invention.

The inventor of the present invention has a pending patent application, U.S. patent application Ser. No. 10/859,374. This application describes a method for giving a concrete surface visual and tactile detectable warnings as well as the product of this method as well as the components involved. The method describe a way to apply truncated domes to a surface through the process of drilling a hole in the concrete and then filling it with a dome that has a bottom long and wide enough to fit into the hole. If necessary, epoxy can be added for a secure fit. This method is inexpensive, not very labor intensive, and can be completed in a short amount of time. However, the present invention is even less labor intensive and even quicker.

U.S. Pat. No. 6,832,871 describes a system and method for automatically applying collated road markers to roadway surfaces. The method uses a type of sticker sheet and adhesive similar to that which we are trying to achieve in this present application, although the method, purpose and resulting product are very different. The actual adhesive used in this patent, however, may also be useful as the adhesive in our present invention.

What is needed is an inexpensive and less labor intensive way to produce detectable warning systems on ramps, curbs, walkways and the like in which there is no danger of the truncated domes coming loose or the surface becoming dangerous, thus increasing the danger to those who cross as opposed to decreasing it. This system must also comply with the ADA.

### BRIEF SUMMARY OF THE INVENTION

The present invention sets forth a method for giving a concrete surface visual and tactile detectable warnings through adhesive means as well as the product of this method and the components involved. This method can be used on new or existing surfaces, thus already placing it above the on-site stamping method. The present invention can be used on any surface that is required to have detectable warnings pursuant to the ADA but is not limited to just those surfaces. Other applications have arisen including using the present invention for adding texture to surfaces on loading docks and in warehouses where extra texture on the ground surface may decrease the chances of workers slipping and dropping or damaging goods.

In brief summary, the method describes ways of applying truncated domes on an area where they may be required or desired. This marking application can be done either by apply a pre-made map to the surface or by measuring the surface by hand and making marks. The pre-made map can take different forms. The best embodiment is a sticker sheet that is cut in the shape of the surface requiring the detectable warnings. The sticker sheet has holes in it at each spot where a dome should be placed. The buttons used for this method are shaped as a dome on top and the bottom is flat so that it can sit flush on the surface. These buttons also have little cavities in them to house the adhesive. Another embodiment can be a sticker sheet that has pre-attached buttons. The sheet is adhered to the top of the domes or buttons that are arranged according to the size of surface that is to be treated. The buttons themselves are coated with an adhesive on the bottom capable of securely adhering the button to the desired surface. There may or may not be a paper backing on the bottom of the domes that would be necessary to peel off before application to the surface. The bottoms of these buttons are likely completely flat. Choosing between these two embodiments depends on the needs of the installer.

Installation of said buttons is simple. When using the sticker sheet with holes, the sheet is first stuck on the surface to be treated. Next, epoxy or some type of adhesive is applied to the underside of the buttons and they are placed in the holes of the sheet and pressed firmly onto the surface. The sheet is then peeled off the surface.

Installing the buttons for the sticker sheet with the pre-attached buttons method is even easier. All that is required is to place the sheet on the desired surface, with the bottom of the buttons facing down. Next the top of the sticker sheet is pressed firmly to secure the buttons to the surface and the top of the sticker sheet is removed.

Another embodiment of the present invention is one in which no sticker sheet template is required. The installer merely makes a mark on the surface in each spot that a button should go and then applies the buttons to the surface at each said mark using an adhesive.

In the unlikely event that one of these buttons becomes loose, a replacement can be easily installed. Therefore, the present invention claims the two-ply sticker sheet, method, button, and resulting surface as well as the one-ply sticker sheet, method, button and resulting surface.

The resulting concrete surface is intended to comply with the ADA regulations for detectable warnings not only in their shape but also in their color. Said surfaces shall contrast visually with adjacent walking surfaces, either light-on-dark, or dark-on-light. In relation to their size, detectable warning surfaces shall extend 24 inches minimum in the direction of travel and the full width of the curb ramp, landing, or blended transition.

### DETAILED DESCRIPTION OF THE INVENTION

The present invention is intended to create detectable warnings on surfaces as required by the ADA Accessibility Guidelines to further protect individuals in society who are blind or visually impaired. Also, as the language of the law evolves, this invention has the ability to change accordingly. Also, it is not limited to those surfaces. This invention can be used on any surface where it is desirable to create visual and tactile detectable warnings for pedestrian traffic. This is the reason in which some presented claims have very specific guidelines for creating the detectable warnings and others are broader. We feel this is necessary so that our invention may encompass any surface on which a detectable warning system is necessary.

The present invention is based on a system in which buttons are adhered to a concrete surface in a set pattern. On surfaces that the ADA is requiring detectable warnings to be present, the set pattern shall reflect the Accessibility Guidelines of the ADA for detectable warning systems. On all other surfaces, any predetermined pattern is possible. The actual concrete surface in question can be prepared by mixture of any composition acceptable in the industry.

The present invention has four different parts that may be pre-manufactured. The first is the sticker sheet with holes in it used to mark the concrete surface where each detectable warning is to be placed. The second is the sticker sheet with the domes attached in a predetermined pattern to the sticker sheet on the top of the dome. The domes may or may not also have a paper backing on the bottom to protect the adhesive on the domes before installation. The third and fourth are the actual detectable warning truncated dome to be placed in the surface. Two different types of domes are described in the patent, although they are likely interchangeable within the two different described methods.

Two different methods of applying the domes in a set pattern are embodied in our claims. One is using a pre-made map or template that can adhere to the surface. Two different types of templates are claimed. The second is to measure and place the domes down by hand. The first and perhaps most effective method is to use a pre-made mapping system in the form of a sticker that has been manufactured and cut to stick directly onto the concrete surface where the detectable warnings are to go. Said sticker sheet can either have holes in it in the predetermined pattern corresponding directly to where each detectable warning truncated dome is to be placed, or the domes can already be attached to the sticker sheet. In the event the surface is one falling under the ADA Accessibility Guidelines, each hole or dome on the sticker is to be placed with a center-to-center spacing of 2.35 inches measured along one side of a square arrangement. Said sticker sheet is to be cut in the exact shape of the surface requiring the warnings. There may be paper backing on the sticker sheet which would be necessary to remove before it is placed directly on the concrete surface. If the sticker sheet with the pre-attached domes is being used, the paper backing would be on the bottom of the domes. As stated above, both varieties of sticker sheets could be pre-manufactured.

The other part of the present invention that must be pre-manufactured are the truncated domes themselves. We call our embodiment of the truncated domes “buttons”. The buttons are to be made of a nylon or plastic material that is very durable and can withstand abuse from heavy amounts of traffic including shoes, wheelchairs, and anything else that might be reasonably expected to cross over them. Two different variations of buttons are embodied in our claims. Both have a truncated dome top with a suggested diameter of 0.9 inch at the bottom, a suggested diameter of 0.4 inch at the top and a suggested height of 0.2 inch The difference between the two is in relation to the bottom of the buttons. One has two small cavities up into the center of the button that can encapsulate the adhesive. This button will still lay flush with the surface because the diameter of the bottom is completely flat. This button does not need to be pre-treated with adhesive; doing so is part of the process of its installation. The other does not have these cavities and is flat all the way across the bottom. For this embodiment of the button, the bottom of the button is pre-treated with an epoxy or other type of adhesive capable of adhering to both concrete and plastic or nylon.

The present invention thus embodies a few different variations of applying detectable warnings to a desired surface. These methods include one using a sticker sheet with holes, one using a sticker sheet where the domes are pre-attached, and one in which no template is used.

The first method is believed to be the best mode of carrying out the present invention. This method uses a sticker sheet that is placed directly on the desired surface. As described above, the size of the sticker sheet is to be pre-made to fit perfectly on top of the concrete surface where detectable warnings are to be placed. The sticker sheet is first placed onto the surface by peeling off the paper backing to expose the sticky side and then adhering the sheet perfectly to the concrete. This will result in a surface with a hole in each spot that a detectable warning truncated dome is to be placed. The said holes are to have the same diameter as that of the bottom of the truncated domes used so the resulting surface will be as close to the predetermined pattern as possible. Next, a dome is treated with adhesive and applied to the concrete surface by placing it in the hole in said sticker sheet. Once the holes in the sheet all house a dome, the sticker is pulled off the surface leaving only the domes. The end result is a concrete surface with detectable warnings. If desired, the resulting surface can be stained to match the colors of the domes used.

Another embodiment of our invention uses a sticker sheet that comes with domes already on it. The domes are placed on the sheet in a predetermined pattern. This method is also considered to be the best mode of carrying out the invention. The sticker sheet lies across the top of the domes. The purpose of this arrangement is to keep the domes in the predetermined pattern before affixing them to a surface. Each dome is treated on the bottom with a type of adhesive that is capable of adhering to both the material of the dome as well as the desired surface. The domes may or may not have a paper backing on them. If a paper backing is present, it needs to be removed before the domes are placed on the surface. The method for applying the domes to the surface is to place the sheet on the area where the domes are to be applied. Next, the installer should press firmly on the top of the sheet to ensure a secure application of the domes to the surface. Finally, the sticker sheet is removed from the tops of the domes. The end result is a concrete surface with detectable warnings. If desired, the resulting surface can be stained to match the colors of the domes used.

Another embodiment of our invention is to eliminate the sticker sheet step completely. We call this the measure and apply method. To perform it, the installer measures the concrete surface manually and makes a mark on the surface in each spot where a detectable warning is desired. Then a button treated with adhesive is applied to the surface at each said mark. The applied button can be either one in which there are small cavities on the bottom where adhesive is added directly before the button is applied to the surface or one that is smooth on the bottom and pre-treated with an adhesive. Although the end result would be the same as either sticker sheet method, we do not feel that this is the best embodiment of the invention. However, it may be a more cost effective way of doing it if the installer feels that purchasing or creating a sticker sheet would not be necessary. This method is much more labor intensive than the two other described methods.

Another embodiment of our invention is that we are claiming not only the above described methods for giving concrete surfaces detectable warnings but also the product of these methods—the resulting surfaces themselves. This is meant to encompass any concrete surface containing detectable warnings in the form of individual buttons that have been adhered to the surface individually.

1. A method for giving a concrete surface visual and tactile warnings, including the steps of:
a. Applying a sticker sheet to a concrete surface, said sticker sheet having round holes in a predetermined pattern;
b. Applying an adhesive to the underside of a button, said button to be in the shape of a truncated dome on the top, the underside of which is capable of laying flush with a flat concrete surface but yet having two small cavities in which to encapsulate said applied adhesive, and a diameter equal to that of the holes in said sticker sheet;
c. Applying said button to said concrete surface by placing it in said round hole in said sticker sheet and pressing firmly down so said button is flush with said concrete surface and firmly attached;
d. Repeating the above two steps with other identical button until all holes on said sticker sheet house a button;
e. Peeling said sticker sheet off said concrete surface, thus exposing a concrete surface with visual and tactile detectable warnings adhered directly to it.

2. A concrete surface having visual and tactile detectable warnings, produced by the method of claim 1.

3. A method for giving a concrete surface visual and tactile warnings, including the steps of:
a. Applying an adhesive to a button, said button to be in the shape of a truncated dome on the top, the underside of which is capable of laying flush with a flat concrete surface and having two small cavities in which to encapsulate said applied adhesive;
b. Applying said button to a concrete surface by placing it on said surface and pressing firmly down so said button is flush with said surface and firmly attached to said surface;
c. Repeating the above two steps with other identical buttons, arranging them in a predetermined pattern to achieve said concrete surface with both visual and tactile detectable warnings.

4. A concrete surface having visual and tactile detectable warnings, produced by the method of claim 3.

5. A button that can be used as a visual and tactile detectable warning on a concrete surface, said button shaped as a truncated dome on top and with an underside that is capable of laying flush with a flat concrete surface but having two small cavities in which to encapsulate an applied adhesive.

6. A sticker sheet designed for the purpose of giving a concrete surface visual and tactile detectable warnings essentially comprising:
a. A non-adhesive side;
b. An adhesive side;
c. A non-adhesive paper backing on said adhesive side;
d. A series of holes in said sticker sheet in a predetermined pattern.

7. A sticker sheet designed for the purpose of giving a concrete surface visual and tactile detectable warnings essentially comprising:
a. A non-adhesive side;
b. An adhesive side;
c. Buttons adhered to said adhesive side in a predetermined pattern, said button to include the elements of:
i. The shape of a truncated dome on thee top;
ii. Flat on the bottom providing the capability to lay flush with a flat concrete surface;
iii. Said bottom treated with an adhesive.

8. A method for giving a concrete surface visual and tactile detectable warnings including the steps of:
a. Placing a sticker sheet on desired concrete surface, button side down, with said sticker sheet to include the elements of:
i. A sheet with an non-adhesive side and an adhesive side;
ii. Buttons adhered to said adhesive side in a predetermined pattern, said button to include the elements of:
1. The shape of a truncated dome on the top;
2. Flat on the bottom providing the capability to lay flush with a flat concrete surface;
3. Said bottom treated with an adhesive;
b. Pressing firmly down on top of said sticker sheet to ensure said button beneath are pressed firmly and flush with said concrete surface;
c. Peeling said sheet off the top of said buttons thus leaving said domes exposed, resulting in a concrete surface fitted with visual and tactile detectable warnings.

9. A concrete surface having visual and tactile detectable warnings, produced by the method of claim 8.

10. The sticker sheet described in claim 7, further comprising the element of a non-adhesive paper backing covering the adhesive on bottom of said button.

11. A method for giving a concrete surface visual and tactile detectable warnings including the steps of:
a. Acquiring a sticker sheet designed for the purpose of giving a concrete surface visual and tactile detectable warnings essentially comprising:
i. A non-adhesive side;
ii. An adhesive side;
iii. Buttons adhered to said adhesive side in a predetermined pattern, said button to include the elements of:
iv. The shape of a truncated dome on thee top;
v. Flat on the bottom providing the capability to lay flush with a flat concrete surface;
vi. Said bottom treated with an adhesive and covered with a non-adhesive paper backing;
b. Peeling off said non-adhesive paper backing covering the adhesive on bottom of said button;
c. Pressing firmly down on top of said sticker sheet to ensure said button beneath are pressed firmly and flush with said concrete surface;
d. Peeling said sheet off the top of said buttons thus leaving said domes exposed resulting in a concrete surface fitted with visual and tactile detectable warnings.

12. A concrete surface having visual and tactile detectable warnings, produced by the method of claim 11.

13. A button that can be used as a visual and tactile detectable warning on a concrete surface essentially comprised of:
a The shape of a truncated dome on top;
b. A flat bottom providing the capability to lay flush with a flat concrete surface;
c. An adhesive on the bottom of said button capable of adhering securely to both concrete and the material of said button.
